(19) United States
(12) Patent Application Publication
(10) Pub. No.: US 2023/0316227 A1
(43) Pub. Date: Oct. 5, 2023

(54) INFORMATION PROCESSING APPARATUS, NON-TRANSITORY COMPUTER READABLE MEDIUM, AND METHOD

(71) Applicant: FUJIFILM Business Innovation Corp., Tokyo (JP)

(72) Inventor: Atsushi SUGIURA, Kanagawa (JP)

(73) Assignee: FUJIFILM Business Innovation Corp., Tokyo (JP)

(21) Appl. No.: 17/885,067

(22) Filed: Aug. 10, 2022

(30) Foreign Application Priority Data
Mar. 25, 2022 (JP) 2022-049231

(51) Int. Cl. H04L 51/02; H04L 51/216; G06Q 10/10; G06Q 50/00

(52) U.S. Cl. CPC G06Q 10/10; G06Q 50/01; H04L 51/02; H04L 51/216

(57) ABSTRACT

An information processing apparatus includes a processor configured to, to create application information that is necessary to obtain approval in response to a post from an applicant to a messenger app for requesting an application, if item information to be included in the application information is not obtained from the post from the applicant to the messenger app, compensate for the item information by referring to a history of conversation with the applicant using the messenger app.

### CROSS-REFERENCE TO RELATED APPLICATIONS

This application is based on and claims priority under 35 USC 119 from Japanese Patent Application No. 2022-049231 filed Mar. 25, 2022.

### BACKGROUND

### (I) Technical Field

The present disclosure relates to an information processing apparatus, a non-transitory computer readable medium, and a method.

### (Ii) Related Art

In the related art, a web chat is used as an application tool when messages are exchanged by using computers. The web chat enables real-time conversation via the Internet. In recent years, a dedicated service called “business chat” has also emerged, and an increasing number of companies are adopting such service as an in-house communication tool instead of email.

For example, for business chat, a technique has been proposed for providing, to an approver, settlement application information received from an applicant via a chatbot and providing, to the applicant, a result of approval by the approver who has referred to the settlement application information (for example, Japanese Unexamined Patent Application Publication No. 2018-200686).

In addition, by using Concur Bot for Slack operating on Slack, which is a typical business chat, a user may easily register an expense by uploading a receipt or obtain an expense report list, for example.

### SUMMARY

However, in some cases, it is not possible to create application information that is necessary to obtain approval because information is insufficient with item information received from the applicant. In such a case, in the related art, the lacking item information is compensated for by using a default value or by having an applicant select an appropriate item value among plural preset item values. In other words, it is necessary to prepare beforehand item information that is necessary for compensation.

Aspects of non-limiting embodiments of the present disclosure relate to creation of application information that is necessary to obtain approval in response to a post to from an applicant a messenger app for requesting an application, without inquiring of the applicant, even if item information to be included in the application information is not obtained from the post to the messenger app.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to, to create application information that is necessary to obtain approval in response to a post from an applicant to a messenger app for requesting an application, if item information to be included in the application information is not obtained from the post from the applicant to the messenger app, compensate for the item information by referring to a history of conversation with the applicant using the messenger app.

### BRIEF DESCRIPTION OF THE DRAWINGS

Exemplary embodiments of the present disclosure will be described in detail based on the following figures, wherein:

FIG. 1 is an overall configuration diagram of a reimbursement system in a first exemplary embodiment;

FIG. 2 is a flowchart illustrating processing performed when chat is used in the first exemplary embodiment;

FIG. 3 illustrates some of messages in conversation in a chat room of a project team in the first exemplary embodiment;

FIG. 4 illustrates a data structure example of system characteristic information used in the first exemplary embodiment;

FIG. 5 is a flowchart illustrating an application information creating process in the first exemplary embodiment;

FIG. 6 illustrates a data structure example of application information in the first exemplary embodiment;

FIG. 7 illustrates a conversation example in a case where an approver is requested for approval in the first exemplary embodiment;

FIG. 8 is a flowchart illustrating an application information creating process in a second exemplary embodiment;

FIG. 9 illustrates some of messages in conversation in a chat room of a project team in the second exemplary embodiment;

FIG. 10 illustrates some of messages in conversation of another pattern in the chat room of the project team in the second exemplary embodiment;

FIG. 11 illustrates some of messages in conversation in a chat room of a project team in a third exemplary embodiment;

FIG. 12 is an overall configuration diagram of a reimbursement system in a fourth exemplary embodiment;

FIG. 13 is a flowchart illustrating an application information creating process in the fourth exemplary embodiment; and

FIG. 14 illustrates some of messages in conversation in a chat room of a project team in the fourth exemplary embodiment.

### DETAILED DESCRIPTION

Exemplary embodiments of the present disclosure will be described with reference to the drawings.

### First Exemplary Embodiment

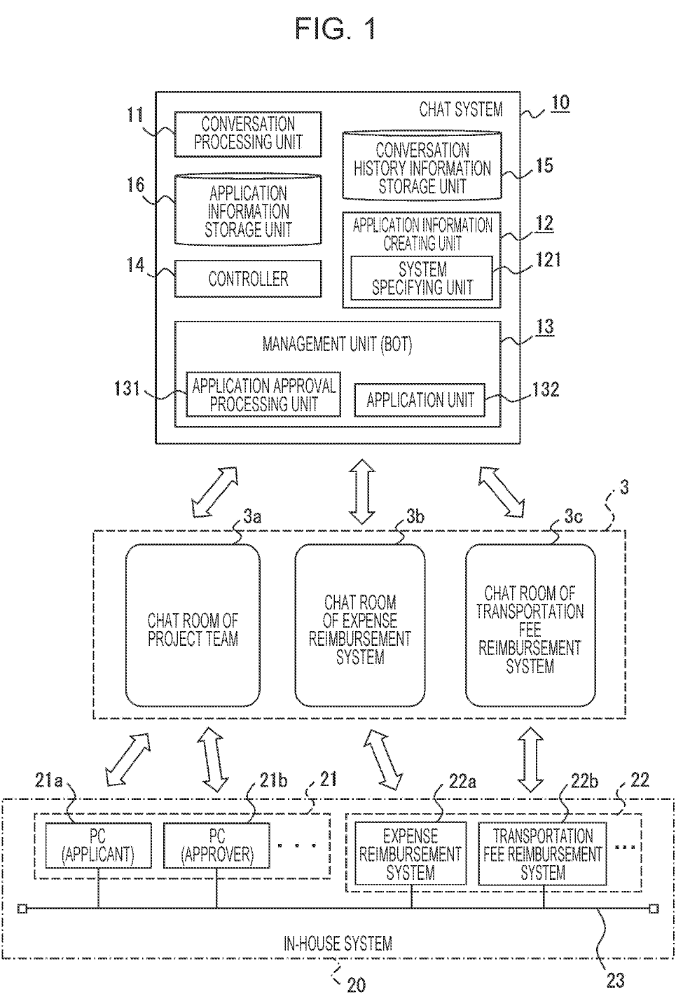

FIG. 1 is a block configuration diagram of an overall configuration of a reimbursement system and a chat system 10 in this exemplary embodiment. FIG. 1 illustrates the chat system 10 and an in-house system 20 that is communicably connected to the chat system 10 via a network (not illustrated). The in-house system 20 is a local area network (LAN) system constructed in a facility of a company. An employee or the like (hereinafter “user”) of the company needs to create application information for reimbursement of an expense incurred by work and to submit the application information for making an application for an in-house core system 22 that is a predetermined application destination. In addition, before providing the application information to the core system 22, the user needs to obtain approval by having an approver check the content of the application information. That is, the application information is necessary to make a reimbursement application and to obtain approval from the approver. The reimbursement system in this exemplary embodiment is a system that enables the applicant to make an application for the core system 22 and to request the approver for approval by using the chat system 10.

The chat system 10 is provided outside the in-house system 20 in FIG. 1, but may be provided inside the in-house system 20.

A web chat is defined as, for example, a mechanism for real-time conversation via the Internet. The chat system 10 provides a chat service to a user who uses a computer in which a chat app for implementing a web chat is installed.

In addition, the term “messenger app” is, for example, a generic term of application software that provides exchange of text messages or exchange of messages using a free Internet protocol (IP) phone or the like, that is, a messaging function. This exemplary embodiment describes, as an example, a case of providing the messaging function to the user by using a chat app as the messenger app. However, for example, another messenger app that provides the messaging function may also be used.

The in-house system 20 is configured by a personal computer (PC) 21 and the core system 22 being connected to a LAN 23. The PC 21 is an information processing apparatus used by the user. The PC 21 may be implemented by a general-purpose hardware configuration that has been existed. That is, the PC 21 includes a central processing unit (CPU), a read only memory (ROM), a random access memory (RAM), a storage such as a hard disk drive (HDD), a network interface as a communication means, and a user interface including an input means such as a mouse or a keyboard, and a display means such as a display. The chat app is installed in the PC 21, and messages are exchanged with a PC 21 used by another user, for example, via the chat system 10. As will be described later, the PC 21 includes a PC 21a used by the applicant and a PC 21b used by the approver.

The user may have chat by using a PC outside the company instead of the PC 21 included in the in-house system 20. For example, when the applicant is out of the office, by using a web chat, the applicant may make an application for the core system 22 or request the approver to pre-check the application information. In addition, when the approver is out of the office, the approver may check the application information in response to the request from the applicant and return an approval result. However, for the convenience of description, the applicant and the approver in this exemplary embodiment use the PC 21a and the PC 21b in the office, respectively, for application and approval.

Note that the information processing apparatus used by the user who uses the chat system 10 is the PC 21 as an example in this exemplary embodiment. However, the information processing apparatus is not limited to this and may be any device for which a chat app is available, such as a smartphone.

The core system 22 is a system that receives, records, and manages an application approved by the approver. The core system 22 may be implemented by a general-purpose hardware configuration that has been existed, such as a server computer. That is, the core system 22 includes at least a CPU, a ROM, a RAM, a storage such as a hard disk drive (HDD), and a network interface as a communication means. This exemplary embodiment illustrates an expense reimbursement system 22a and a transportation fee reimbursement system 22b as examples of the core system 22. Note that the expense reimbursement system 22a and the transportation fee reimbursement system 22b will be collectively referred to as “core system 22” when they are not distinguished from each other.

As described above, the chat system 10 provides a chat service to the user of the PC 21 in which the chat app is installed. The chat system 10 is an example of the information processing apparatus according to an exemplary embodiment of the present disclosure and may be implemented by a general-purpose hardware configuration that has been existed, such as a server computer. That is, the chat system 10 includes at least a CPU, a ROM, a RAM, a storage such as a hard disk drive (HDD), and a network interface as a communication means.

The chat system 10 includes a conversation processing unit 11, an application information creating unit 12, a management unit 13, a controller 14, a conversation history information storage unit 15, and an application information storage unit 16. Note that structural elements not used in the description of this exemplary embodiment are omitted from the illustration.

The conversation processing unit 11 performs processing related to exchange of messages, so-called conversation, performed by the user of the PC 21 posting messages to a chat room 3. The conversation processing unit 11 stores the posted messages as conversation history information in the conversation history information storage unit 15. More specifically, the conversation processing unit 11 acquires a message posted to a web page (the above “chat room”) provided by the chat system 10 as a place for exchange of messages in a specific group, and accumulates the conversation history information including the content of the acquired message in the conversation history information storage unit 15. The conversation history information includes at least the date and time when the message is posted, the poster, the content of the post (that is, the message), and the identification information of the chat room 3 to which the message is posted.

The application information creating unit 12 creates application information in response to an application instruction from the user using the chat app, and stores the created application information in the application information storage unit 16. In this exemplary embodiment, item values in item information set in the application information is pre-checked by the approver. A system specifying unit 121 included in the application information creating unit 12 specifies the core system 22 to which the application information is to be transmitted.

The management unit 13 manages the application for the core system 22 and application approval. The management unit 13 includes an application approval processing unit 131 and an application unit 132. The application approval processing unit 131 presents the application information created by the application information creating unit 12 to the approver and obtains an approval result from the approver. The application unit 132 transmits the application information approved by the approver to the core system 22, thereby making a reimbursement application.

The controller 14 operates in cooperation with the conversation processing unit 11, the application information creating unit 12, and the management unit 13 described above, thereby controlling conversation in the chat system 10 and controlling application and approval processing.

FIG. 1 further illustrates chat room 3a, 3b, and 3c generated by the chat system 10 as places where messages are exchanged in a project team and with each of the expense reimbursement system 22a and the transportation fee reimbursement system 22b. The project team includes users including the applicant and the approver. Note that the chat room 3a, 3b, and 3c will be collectively referred to as “chat room 3” when they are not distinguished from one another. The chat system 10 not only generates the illustrated chat room 3 limitedly but also generates, for example, a chat room 3 for conversation between two people on demand.

The conversation processing unit 11, the application information creating unit 12, the management unit 13, and the controller 14 in the chat system 10 are implemented by collaborative work between a computer configuring the chat system 10 and a program that operates on the CPU installed in the computer. In addition, the conversation history information storage unit 15 and the application information storage unit 16 are implemented by the HDD installed in the chat system 10. Alternatively, a RAM or an external storage means may be used via a network.

Programs used in this exemplary embodiment may be provided as a result of being stored in a computer readable recording medium, such as a compact disc (CD)-ROM or a universal serial bus (USB) memory, as well as being provided by a communication means. As a result of the programs provided by a communication means or a recording medium being installed into a computer and being sequentially executed by the CPU of the computer, various processes may be executed.

Next, operations in this exemplary embodiment will be described.

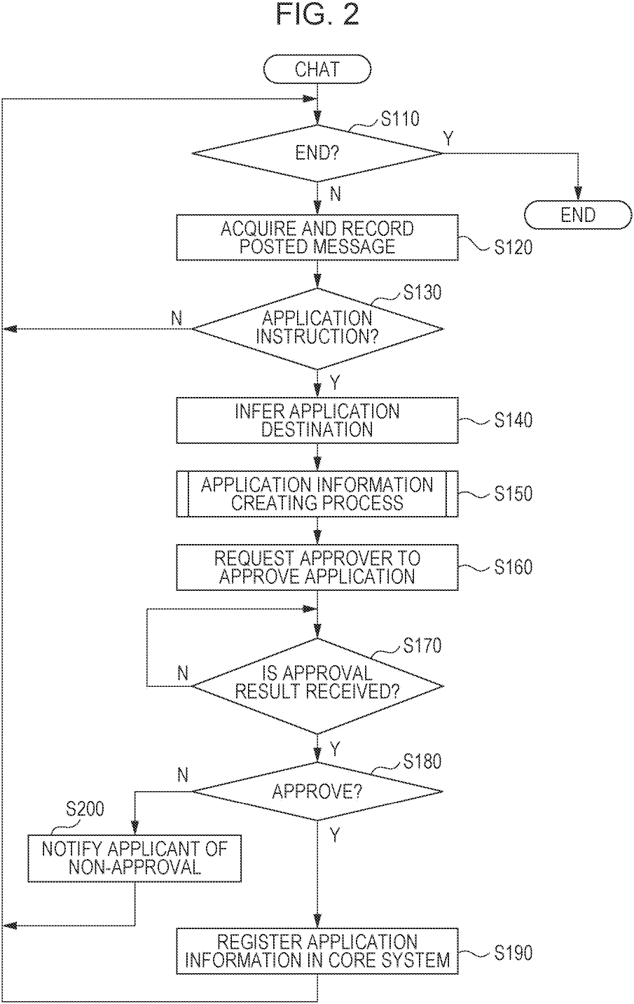

A user (that is, “applicant”) makes an application for a corresponding core system 22 for the purpose of reimbursement of an expense or the like. The reimbursement system in this exemplary embodiment performs processing in the following procedure. Before an application for the core system 22 is made, the content of the application is presented to the approver, and after approval from the approver is obtained, the application for the core system 22 is made. The applicant makes the application for the core system 22 by using web chat. Hereinafter, the processing in the chat system 10 when using web chat will be described with reference to the flowchart illustrated in FIG. 2.

The applicant starts a chat app and, by using the chat room 3a of the project team, starts conversation with other project members. Subsequently, the applicant conducts conversation by using the functions provided by the conversation processing unit 11 until the conversation ends (Y in step S110). While messages are exchanged among project members (N in step S110), each time a message is posted, the conversation processing unit 11 acquires the posted message, generates conversation history information, and records it in the conversation history information storage unit 15 (step S120). If the acquired message does not correspond to a post from the applicant to a chat app for requesting an application (N in step S130), the process proceeds to step S110. Note that the post from the applicant to the chat app for requesting an application means, in a more precise sense, a post of a message by the applicant to the chat room 3 provided by the chat app for the purpose of reimbursement application.

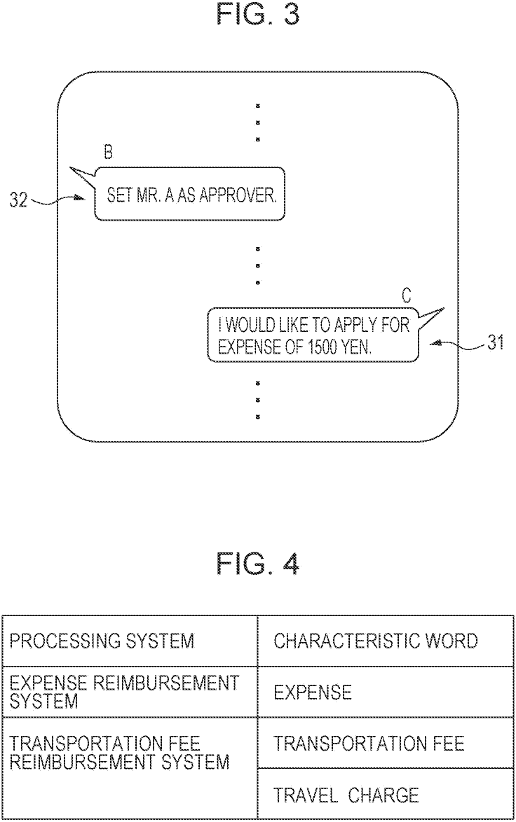

FIG. 3 illustrates some of messages in conversation in the chat room 3a of the project team. FIG. 3 is an example of the chat room 3a displayed on the PC 21a of a user C. Note that a user B is one of the project team members. The content of the conversation illustrated in FIG. 3 is recorded as the conversation history information in the conversation history information storage unit 15. In this conversation example, since the user C posts a message 31 including the phrase “apply for expense”, it is understood that the user C corresponds to the applicant. That is, the conversation processing unit 11 interprets the content of the conversation by natural language processing, and, on the basis of the word “apply” included in the message posted by the user C, recognizes the message 31 from the user C as an application instruction for requesting an application and the user C as the applicant. As a matter of course, the determination of the application instruction is not necessarily limited to the word “apply”, and the determination may be performed by interpreting the context of the conversation. In addition, if a document is attached, for example, not only the content of the message but also the document may be analyzed. For example, if a read image of a document such as a receipt is attached, the image may be subjected to character recognition processing, and, on the basis of characters extracted by the character recognition processing, it may be determined whether the message is an application instruction. Note that the conversation processing unit 11 determines whether the message is an application instruction in the above description. However, another structural element, such as the application information creating unit 12 or the controller 14, may determine whether the message is an application instruction.

If it is determined that an application instruction is issued (Y in step S130), the application information creating unit 12 starts creating application information. Initially, the system specifying unit 121 infers the core system 22 that is the application destination by referring to the conversation history information (step S140). Specifically, the system specifying unit 121 extracts words and phrases included in the message by natural language processing, in particular, morphological analysis processing, and checks against preset system characteristic information.

FIG. 4 illustrates a data structure example of system characteristic information used in this exemplary embodiment. The system characteristic information is set in a storage means (not illustrated) that the system specifying unit 121 may refer to or in the system specifying unit 121. In the system characteristic information, each of pieces of identification information (system name in this exemplary embodiment) of the core system 22 that is an application destination candidate is associated with a unique word or phrase indicating the characteristic of the core system 22 as a characteristic word. The characteristic word may be set by being acquired from a corresponding core system 22.

According to the characteristic word setting example illustrated in FIG. 4, the word “expense” extracted from the message 31 in the conversation history corresponds with the characteristic word for the expense reimbursement system 22a. Thus, the system specifying unit 121 specifies the expense reimbursement system 22a as the core system 22 that is the application destination. In this manner, if any characteristic word included in the system characteristic information is present in the conversation history, the system specifying unit 121 infers and specifies the core system 22 corresponding to the identification information associated with the characteristic word as the core system 22 that is the application destination.

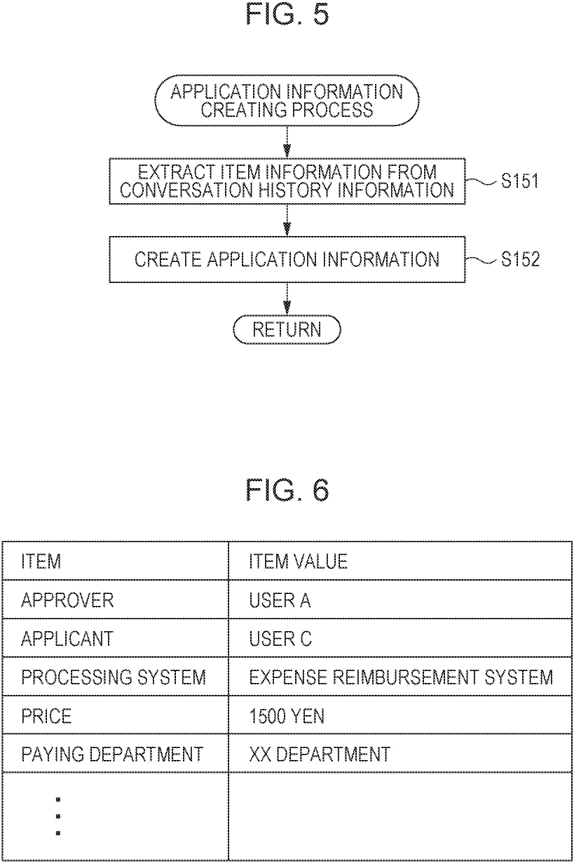

As a matter of course, a characteristic word of another core system 22, such as “travel charge”, may be included in the conversation history of the project team. However, in the message example illustrated in FIG. 4, since the expression “apply for expense” is present, the system specifying unit 121 interprets the content of the conversation by natural language processing and specifies the expense reimbursement system 22a as the application destination. Subsequently, the application information creating unit 12 performs an application information creating process (step S150). Hereinafter, specific processing in the application information creating process will be described with reference to the flowchart illustrated in FIG. 5.

The application information creating unit 12 acquires the conversation history information of the project team included in the conversation history information storage unit 15, interprets the content of the conversation by natural language processing, and extracts item information to be included in the application information (step S151).

FIG. 6 illustrates a data structure example of the application information in this exemplary embodiment. The item information to be included in the application information is set in the application information. In the item information, an item is associated with an item value corresponding to the item.

In the conversation with other members, the applicant is likely to have mentioned information that is necessary to create the application information. Thus, as described above, the application information creating unit 12 analyzes the message posted by the applicant by natural language processing, extracts the item value to be included in the application information, generates item information by associating the item value with the corresponding item name, and includes the item information in the application information. However, it is not always possible to extract, from the message posted by the applicant, the item value corresponding to all pieces of the item information to be included in the application information. Thus, in this exemplary embodiment, messages posted by users other than the applicant are also referred to. That is, by referring to the conversation history using the group chat of the project team including the applicant, in order words, messages of other project members, the application information creating unit 12 extracts the item information to be included in the application information. In the conversation example illustrated in FIG. 3, on the basis of a message 32 of the user B, a user A may be specified as the approver.

Note that the conversation history from which the item information is extracted is not limited to the conversation history of the project team. A conversation history between the applicant and a project member or a conversation history between the applicant and a user other than the project members may also be referred to.

In the above manner, from the conversation history information, the application information creating unit 12 extracts the item information to be included in the application information, thereby creating the application information (step S152). At this time, if the necessary item information is not obtained from the message of the applicant, by referring to messages posted by other project members included in the conversation history information, the application information creating unit 12 compensates for the item information, thereby completing the application information.

In some cases, the item information to be included in the application information is basically information that is necessary for the core system 22, and thus, the item information to be included in the application information may differ depending on the core system 22. Note that in the data structure example illustrated in FIG. 6, identification information of the processing system for processing an application, that is, the core system 22, corresponds to a piece of the item information to be included in the application information. However, in this exemplary embodiment, since the core system 22 to which the application information is to be transmitted is specified in advance in step S140, the type of item information to be extracted and acquired from the conversation history information may be specified in advance. That is, it is possible to create the application information in accordance with the core system 22 that is the application destination of the application information.

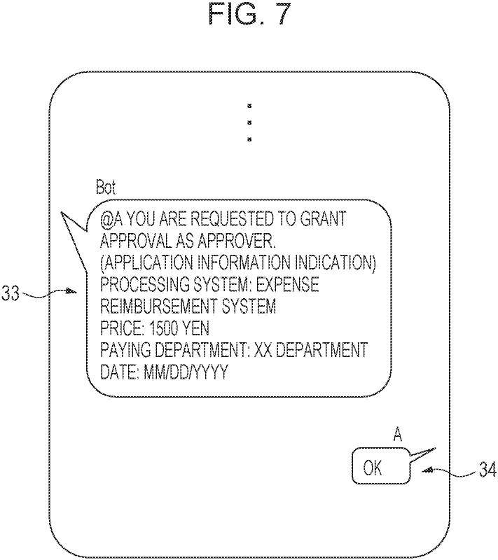

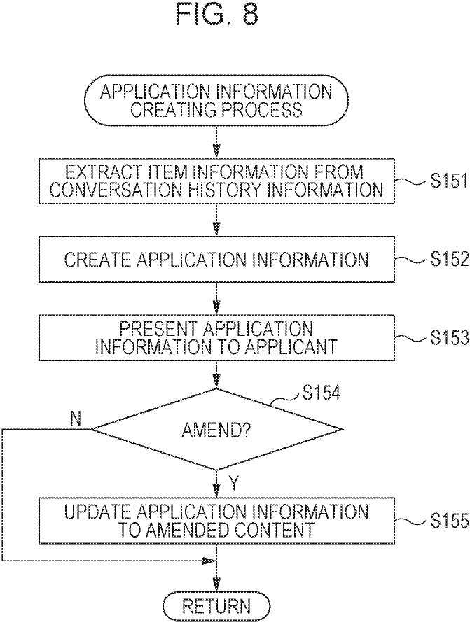

Referring back to FIG. 2, upon the application information creating unit 12 creating the application information, the application approval processing unit 131 in the management unit 13 requests the approver who may be specified by referring to the application information, to approve the application by presenting the application information (step S160). In this exemplary embodiment, a chatbot configuring the management unit 13 is caused to post a message to the chat room 3a of the project team. In this case, by explicitly mentioning that the user A is the approver by using mention, the user A as the approver may be requested for approval. FIG. 7 illustrates a conversation example in a case where the approver is requested for approval by a message posted to the chat room 3a of the project team in the above manner.

Alternatively, the application approval processing unit 131 may request for approval by posting a message to a chat room with the approver. If no chat room with the approver is generated yet, a chat room may be generated then. Note that, in a precise sense, the conversation processing unit 11 acquires conversation with the user, that is, a posted message, and thus, the application approval processing unit 131 causes the conversation processing unit 11 to post a message. However, the description herein may include an expression such as “the application approval processing unit 131 posts a message” for the convenience of description.

In response to a message 33 that requests for approval being posted, the approver checks the content of the application information and indicates an approval result as to whether approval is obtained by posting a message 34. The application approval processing unit 131 waits for reception of the approval result from the approver (that is, whether approval is obtained) (N in step S170). Upon reception of the approval result from the approver (Y in step S170), if the approval result indicates that the application is approved (Y in step S180) as illustrated in FIG. 7, the application unit 132 in the management unit 13 posts a message including the application information to the chat room with the core system 22 that may be specified on the basis of items of a processing system included in the application information, thereby registering the application information (step S190). For example, if the applicant makes an application for an expense as in the above example, the application unit 132 posts a message including the application information to the chat room 3b with the expense reimbursement system 22a.

The applicant may also be notified of the approval result by a message being posted to the chat room 3b or a chat room with the applicant.

By issuing the application instruction from the chat room 3, the applicant may obtain approval from the approver by the operation of the management unit 13 and may also make a reimbursement application for a desired core system 22. In particular, in this exemplary embodiment, even if the item information to be included in the application information to be created in response to the application from the applicant is not obtained from the applicant, the item information is acquired by referring to the conversation history using the web chat without inquiring of the applicant.

On the other hand, if the approval result from the approver indicates that approval is not obtained (N in step S180), the management unit 13 notifies the applicant that approval from the approver is not obtained by posting a message to the chat room 3a of the project team (step S200). In this case, it is possible to explicitly mention that the message reporting the approval result is addressed to the user C, who is the applicant, by using mention. Alternatively, the application approval processing unit 131 may report the approval result by posting a message to a chat room with the applicant. If no chat room with the applicant is generated yet, a chat room may be generated then.

### Second Exemplary Embodiment

In the first exemplary embodiment above, the application information creating unit 12 creates the application information in response to the application instruction from the applicant. However, if all pieces of item information to be included in the application information are not obtained from the applicant, the application information creating unit 12 compensates for the necessary piece of information by referring to the conversation history. In this case, however, the application information may include an item value unknown to the applicant. That is, the application information whose content is not intended by the applicant may be approved and applied for the desired core system 22.

Thus, in this exemplary embodiment, before requesting an approver for approval, the application information created by the application information creating unit 12 is presented in advance to the applicant so as to be checked.

The system configuration (FIG. 1) and the chat processing (FIG. 2) in this exemplary embodiment are the same as those in the first exemplary embodiment. In this exemplary embodiment, the application information creating process (step S150) included in the chat processing, specifically, the flowchart illustrated in FIG. 5, is different from that in the first exemplary embodiment. Hereinafter, the application information creating process in this exemplary embodiment will be described with reference to the flowchart illustrated in FIG. 8. Note that the same steps as those in the application information creating process (FIG. 5) in the first exemplary embodiment are denoted by the same reference numerals, and the description thereof will be omitted as appropriate.

The application information creating unit 12 extracts, from the conversation history information, the item information to be included in the application information (step S151) and creates the application information by compensating for information as necessary (step S152). However, the application approval processing unit 131 in this exemplary embodiment presents the created application information to the applicant (step S153). For example, as in step S200 in the first exemplary embodiment, the application information is presented by a message posted to the chat room 3 with the project team or the applicant.

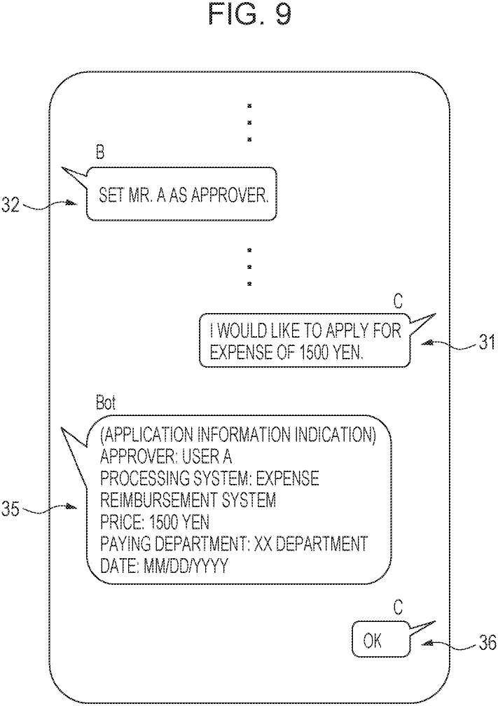

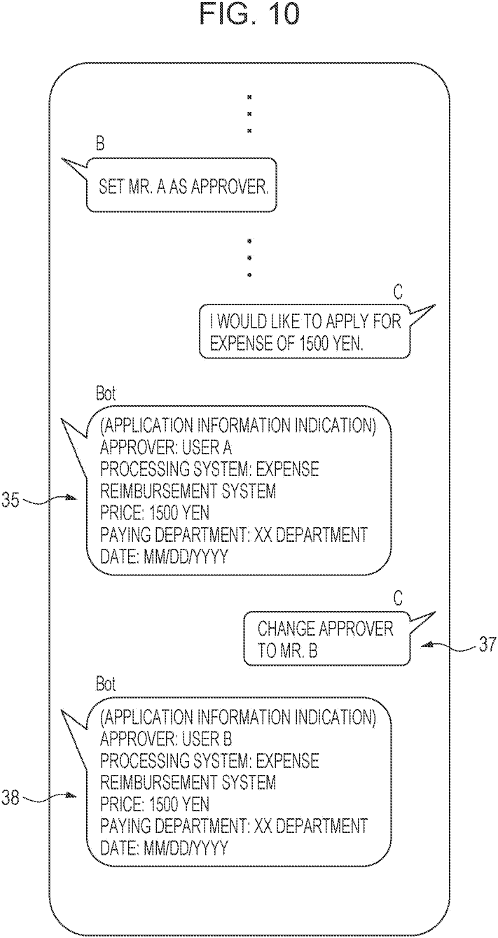

FIG. 9 illustrates some of messages in conversation in the chat room 3a of the project team and illustrates conversation following that in FIG. 3. FIG. 9 illustrates a message 35 including the application information posted by the management unit 13 (that is, the chatbot) following the message 31 that corresponds to the application instruction. The applicant refers to the application information included in the message 35, and, if the content is correct, posts a message 36 indicating no amendments as illustrated in FIG. 9. Upon recognizing no amendments by referring to the message 36 (N in step S154), the application approval processing unit 131 presents the application information created by the application information creating unit 12 to the approver as it is.

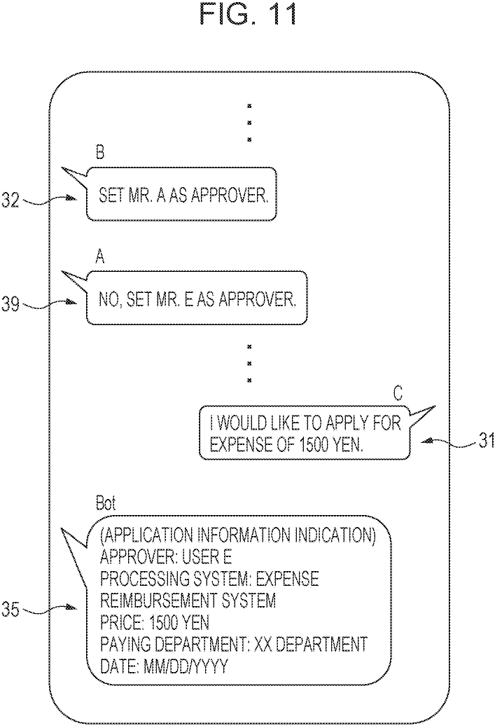

As in FIG. 9, FIG. 10 illustrates some of messages in conversation in the chat room 3a of the project team and illustrates conversation following that in FIG. 3. If the applicant wishes to amend an item value included in the application information, the applicant posts a message 37 indicating the amended content. Upon recognizing that the item information needs to be amended on the basis of the message 37 corresponding to an amendment instruction (Y in step S154), the application information creating unit 12 interprets the content of the message 37 and specifies the item information to be amended. Then, the specified item information, included in the application information presented to the applicant, is updated to the content amended by the applicant (step S155). The application approval processing unit 131 may post a message 38 including the application information updated by the application information creating unit 12 so as to allow the applicant to double-check the content of the application information.

### Third Exemplary Embodiment

As described above, the application information creating unit 12 creates the application information in response to the application instruction from the applicant. However, if all item values to be included in the application information are not obtained from the applicant, the necessary information is compensated for by referring to the conversation history, that is, the conversation history information. However, in some cases, plural messages including the item value to be compensated for regarding the same item are posted. In such a case, it is not possible to specify the item value to be set. Thus, in this exemplary embodiment, if there are plural candidates for information that compensates for the item information to be included in the application information, information to be adopted, that is, one item value, may be selected among the plural candidates in accordance with a predetermined selection criterion.

The system configuration (FIG. 1) and the chat processing (FIG. 2) in this exemplary embodiment are the same as those in the first exemplary embodiment. In this exemplary embodiment, details of the application information creating process (step S150) included in the chat processing are slightly different. That is, in the flowchart illustrated in FIG. 3, the first exemplary embodiment assumes a case where a unique item value is designated for an item in the processing for extracting the item value from the conversation history information (step S151). However, this exemplary embodiment deals with a case where plural candidates are present for the item value to be set for the item in the conversation history information.

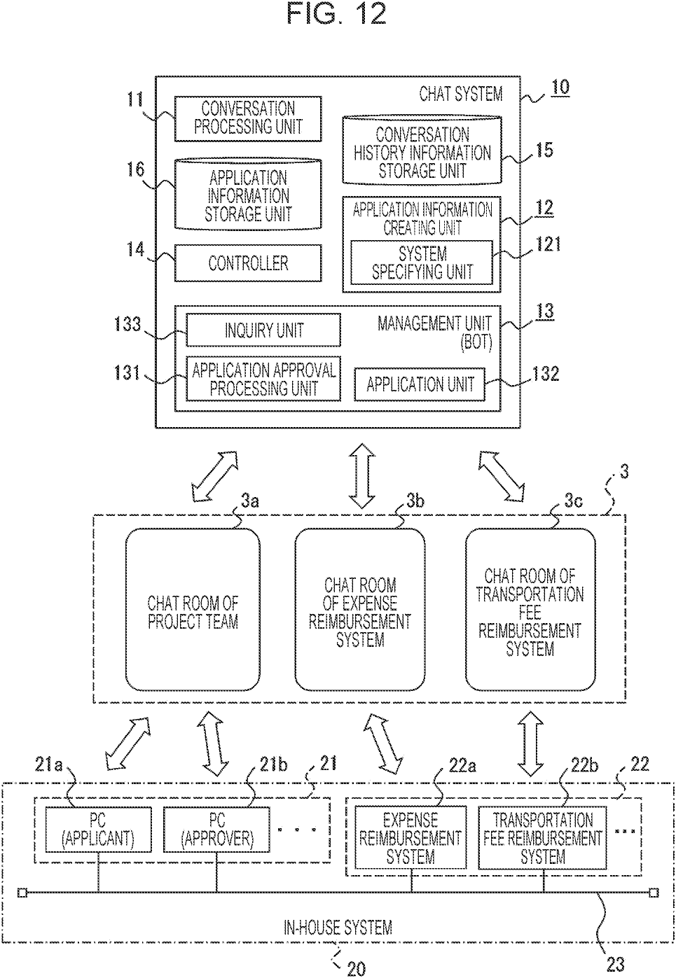

FIG. 11 illustrates some of messages in conversation in the chat room 3a of the project team. After the user B posts the message 32 that designates the user A as the approver as in the case in the first exemplary embodiment (FIG. 3), the user A posts a message 39 that cancels the designation and designates a user E as the approver. In this example, if the conversation history is analyzed, two people, the user A and the user E, are extracted as approvers.

Thus, in this exemplary embodiment, by setting the predetermined selection criterion, one of plural selection candidates may be selected. For example, the predetermined selection criterion to adopt the most recent information among selection candidates is set. In this case, in the conversation illustrated in FIG. 11, the designation of the approver by the user A is the most recent designation. Therefore, the application information creating unit 12 adopts the message 39 posted by the user A and selects the user E as the approver.

In the above description, in accordance with the predetermined selection criterion, the most recent information is selected among the plural selection candidates. However, the predetermined selection criterion is not limited to this. For example, a post from a user with a top priority among plural posters may be adopted. For example, the user with a top priority is a user at the highest position in the company or the project team of the posters, and a post from such a user is adopted. Note that the position may be specified by referring to personal information managed in the company. Similarly, in a case where plural approvers are designated, a user with a top priority, such as the highest position, among the designated plural approvers may be selected. Alternatively, as the selection criterion, since the chat app has started, a user who is likely to be able to return an approval result immediately may be selected as the approver. Furthermore, plural selection criteria may be used in combination. Alternatively, the context, the beginning, or the like of the message may be taken into account. For example, the beginning includes directive, assertive, speculative wording such as “set”, “it is”, or “it may be”, and thus, the degree of affirmation of the wording may be taken into account. In addition, as in the message 39, the wording that cancels the content of the preceding message 32 may be taken into account.

### Fourth Exemplary Embodiment

In each of the exemplary embodiments above, the application information creating unit 12 creates the application information in response to the application instruction from the applicant. However, if all pieces of item information to be included in the application information are not obtained from the applicant, the application information creating unit 12 compensates for the necessary information by referring to the conversation history. However, not all the necessary information may be always extracted from the conversation history. Thus, in this exemplary embodiment, so as to deal with such a case, it is possible to inquire of the applicant.

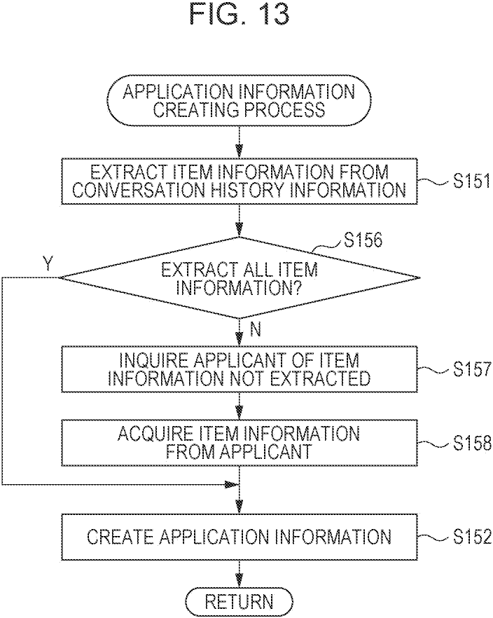

FIG. 12 is a block configuration diagram of an overall configuration of a reimbursement system and the chat system 10 in this exemplary embodiment. The same structural elements as those in the first exemplary embodiment are denoted by the same reference numerals, and the description thereof will be omitted. In this exemplary embodiment, an inquiring unit 133 is added in the management unit 13 to the configuration illustrated in the first exemplary embodiment.

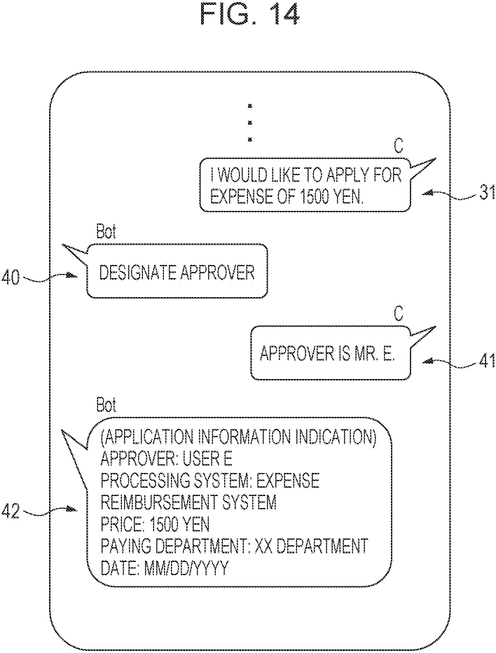

Hereinafter, the operations in this exemplary embodiment will be described, and the chat processing (FIG. 2) is the same as that in the first exemplary embodiment. In this exemplary embodiment, the application information creating process (step S150) included in the chat processing, specifically, the flowchart illustrated in FIG. 5, is different from that in the first exemplary embodiment. Hereinafter, the application information creating process in this exemplary embodiment will be described with reference to the flowchart illustrated in FIG. 13. Note that the same steps as those in the application information creating process (FIG. 5) in the first exemplary embodiment are denoted by the same reference numerals, and the description thereof will be omitted as appropriate.

The application information creating unit 12 extracts, from the conversation history information, the item information to be included in the application information (step S151). Here, if all pieces of the item information to be included in the application information are extracted (Y in step S156), as in the first exemplary embodiment, the application information is created (step S152).

On the other hand, if all pieces of the item information to be included in the application information are not extracted from the conversation history information (N in step S156), the inquiring unit 133 in this exemplary embodiment inquires, of the applicant, the item information that is not extracted (step S157).

FIG. 14 illustrates some of messages in conversation in the chat room 3a of the project team and illustrates conversation following that in FIG. 3. Upon the user C who is the applicant posting the message 31 corresponding to the application instruction, if the application information is not completed as a result of the application information creating unit 12 not extracting, from the conversation history information, all pieces of the item information to be included in the application information, the inquiring unit 133 posts an inquiring message 40 that specifies the lacking item information. In response to this inquiry, the applicant posts a message 41 including the item information.

In this manner, upon the application information creating unit 12 acquiring the item information designated by the applicant (step S158), the application information creating unit 12 creates the application information by using the acquired item information for compensation (step S152).

According to this exemplary embodiment, the item information that has not been compensated for by referring to the conversation history information is acquired by inquiring of the applicant, thereby completing the application information.

Note that the inquiry destination is the applicant as described above. Other than the applicant, for example, a person who is inferred to know necessary information since they are in the same department as the applicant, a superior of the applicant, or the like may also be inquired of. Note that the job relationship with the applicant may be specified by referring to the personal information managed in the company.

Although various methods regarding creation of the application information are described in the exemplary embodiments above, the methods may be performed in appropriate combination as necessary.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to, to create application information that is necessary to obtain approval in response to a post from an applicant to a messenger app for requesting an application, if item information to be included in the application information is not obtained from the post from the applicant to the messenger app, compensate for the item information by referring to a history of conversation with the applicant using the messenger app.

2. The information processing apparatus according to claim 1, wherein:
the processor is configured to:
in a case where the item information to be included in the application information is identification information of a processing system that performs processing in response to the application, if information that specifies the processing system is not obtained from the post to the messenger app used for conversation with the applicant, acquire system characteristic information in which identification information of systems that are candidates for the processing system is associated with a characteristic word indicating the system; and
if any characteristic word included in the system characteristic information is present in the history of conversation with the applicant using the messenger app, infer the system whose identification information is associated with the characteristic word as the processing system.

3. The information processing apparatus according to claim 1, wherein:
the processor is configured to post the application information created by compensation to the messenger app to present the application information to the applicant.

4. The information processing apparatus according to claim 2, wherein:
the processor is configured to receive an amendment instruction for the application information by a post from the applicant to the messenger app.

5. The information processing apparatus according to claim 1, wherein:
the processor is configured to, if the history of conversation with the applicant using the messenger app includes a plurality of candidates for information that compensates for the item information that is not obtained from the post from the applicant to the messenger app, select one of the candidates in accordance with a predetermined selection criterion.

6. The information processing apparatus according to claim 5, wherein:
the predetermined selection criterion is to select most recent information among the candidates.

7. A non-transitory computer readable medium storing a program causing a computer to a process, the process comprising:
to create application information that is necessary to obtain approval in response to a post from an applicant to a messenger app for requesting an application, if item information to be included in the application information is not obtained from the post from the applicant to the messenger app, compensating for the item information by referring to a history of conversation with the applicant using the messenger app.

8. A method comprising:
to create application information that is necessary to obtain approval in response to a post from an applicant to a messenger app for requesting an application, if item information to be included in the application information is not obtained from the post from the applicant to the messenger app, compensating for the item information by referring to a history of conversation with the applicant using the messenger app.
